(19) United States
(12) Patent Application Publication
(10) Pub. No.: US 2024/0298160 A1
(43) Pub. Date: Sep. 5, 2024

(54) SYSTEM AND METHOD FOR AUTOMATIC ARRESTEE GROUPING AND ACTION RECOMMENDATION DURING A MASS INCIDENT ARREST

(71) Applicant: MOTOROLA SOLUTIONS, INC., CHICAGO, IL (US)

(72) Inventors: KELSEY J JOHNSON, STREAMWOOD, IL (US); JOHN A KROL, SCHAUMBURG, IL (US)

(21) Appl. No.: 18/177,785

(22) Filed: Mar. 3, 2023

(51) Int. Cl. H04W 4/90; G06Q 50/26

(52) U.S. Cl. CPC H04W 4/90; G06Q 50/265

(57) ABSTRACT

A communication system and method provide for automatic arrestee grouping and action recommendation during a mass incident arrest. A portable radio sends a notification to a server indicating a mass incident event with grouping request for grouping arrestees. The server returns an electronic form including a mass arrest ID based on type of mass event. The electronic form facilitates collecting individual arrestee information based on the type of mass event. Current offense type and personal attribute information are collected and further electronically tagged to each arrestee. The server automatically assigns each arrestee to an offense group based on current offense type, and then refines the offense group into sub-groups based on prior arrest records. The server generates arrest processing procedure recommendations customized for each sub-group and transmits the recommendations to the PS radio associated with the grouping request.

### BACKGROUND OF THE INVENTION

Group events, such as demonstrations, protests, strikes, and even parties and sports events can sometimes lead into disruptions that require law enforcement to intervene and engage in arrests at an incident scene. Such arrests may require the use of law enforcement transport. The disruptions at the incident scene may further be exacerbated when individuals of opposing viewpoints are being arrested and possibly transported together. Officers may not be able to readily surmise which arrestees may be transported together safely, and loading all arrestees onto one vehicle may endanger both officers and arrestees.

Determining arrestee transport is not always straightforward. For example, a party event involving underage drinking might require some arrestees to be transported to a juvenile detention center, while adults present at the party would need to be transported to a county jail. Parents or other interested parties arriving on scene may also be seeking information as to where their underage child is being transported. Hence, arresting officers may have to deal with many different types of individuals and different types of transport during a mass arrest. Additionally, the processing arrestees upon arrival at a detention or holding facility may be challenging based on individual characteristics of an arrestee not known by the officers.

Current mass arrest procedures generally rely on paper records and officer communication back and forth to dispatch which can be very time-consuming. Accordingly, there is a need to facilitate the organization and transport of arrestees at an incident scene to a processing facility. Improvements which further aid in the facility processing of arrestees would also be beneficial.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments, examples, features, and aspects of concepts that include the claimed subject matter and explain various principles and advantages of those embodiments, examples, features, and aspects.

FIG. 1 is a block diagram illustrating a communication system and workflow according to some embodiments.

FIG. 2 illustrates processing actions taking place based on recommendations provided by the communication system of FIG. 1 according to some embodiments.

FIG. 3 is a flowchart illustrating a method of managing arrests at an incident scene according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various aspects, features, examples, and embodiments.

The apparatus and method components have been represented where appropriate by conventional symbols in the drawings, showing only those specific details that are pertinent to understanding the aspects, features, examples, and embodiments so as not to obscure the disclosure with details that will be readily apparent to those of ordinary skill in the art having the benefit of the description herein.

### DETAILED DESCRIPTION OF THE INVENTION

Briefly, there is provided herein a communication system and method that provide for automatic arrestee grouping and arrest processing procedure recommendations during a mass incident arrest. A portable radio sends a notification to a server indicating a mass incident event with grouping request for grouping arrestees. The server returns a form including a mass arrest ID based on type of mass event. The electronic form facilitates collecting individual arrestee information based on the type of mass event. Current offense type and personal attribute information are collected and further electronically tagged to each arrestee. The server automatically assigns each arrestee to an offense group based on current offense type, and then refines the offense group into sub-groups based on prior arrest records the collected personal attribute information for each arrestee. The server generates arrest processing procedure recommendations customized for each sub-group and transmits the recommendations to the PS radio associated with the grouping request.

The server may be further configured to monitor and compare arrest processing actions taken at the mass arrest event to the arrest processing procedure recommendations. Based on the comparison, the server may further determine accepted recommendations, rejected recommendations and deviated recommendations. The server may make adjustments to the arrest processing procedure recommendations for other grouping requests based on the determined accepted recommendations, rejected recommendations and deviated recommendations.

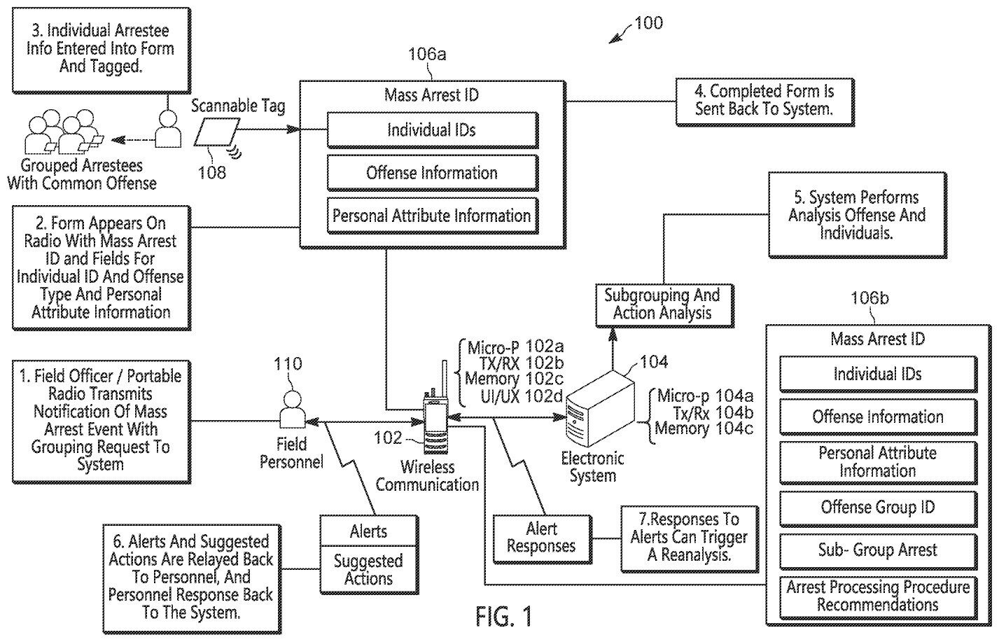

FIG. 1 is a block diagram of a communication system 100 formed and operating in accordance with some embodiments. Communication system 100 includes at least one portable public safety (PS) radio 102 and a public safety server 104 operating over a public safety network. The portable radio 102 is operated by a field officer 110, responding to an incident scene in which mass arrests are being made. The portable radio includes operational capability for communicating with the server 104. For example, the portable radio includes an electronic processor 102a (for example, a microprocessor operating as part of a controller), a memory 102b, transceiver 104c and a user interface 102d, such as an interactive touch display. The server 104 includes an electronic processor 104a (for example, a microprocessor, a central processing unit, or the like), a memory 104b and transceiver 104c capability for communicating with portable radio 102 over a public safety network. The server 104 has access to one or more databases 112, including public-safety (PS) databases and open or publicly accessible databases. The PS databases include but are not limited to criminal records of individuals, PS logs, department of motor vehicle information, court decisions (including civil injunctions), image and video depositories. The open or publicly accessible databases may include, but are not limited, to social media portals, and local government (e.g., county) records, websites, watch lists and/or registries to name a few. Suggested workflows (1, 2, 3, 4, 5, 6) associated with the communication system 100 are also identified in FIG. 1.

Upon arrival at an incident scene, the field officer 110 sends an electronic notification of mass arrest event with grouping request for grouping arrestees from portable radio 102 to the server 104 (workflow 1). The server 104 receives the electronic notification of mass arrest event with grouping request from the portable radio 102. For the purposes of this application, a grouping request is a request to determine safe groupings of individuals being arrested, both from the perspective of the arrestees and the arresting officer, as well as officers involved in later processing of the arrestees, such as officer officers located at a jail, detention center, designated holding place, or the like. The server's processor 104a, in response to the notification, is configured to generate a mass arrest ID based on the type of mass event. The processor 104a is further configured to generate an electronic form 106a, including the mass arrest ID. For example, the mass arrest ID for a mass event may be “sports stadium riot 123”, “political disruption xyz”, “airport strike protest 456”, “party brawl 321”, or other suitable identifier for the disruption. The server transmits the electronic form 106a with mass arrest ID to the requesting PS radio 102. The form may include one or more pull down menus for selecting and entering Offense Information with selections that are associated with the type of incident event.

The electronic form 106a is displayed at portable radio 102 for completion by field officer 110 at the scene (workflow 2). The electronic form 106a displayed at portable radio 102 may be filled in via the portable radio user interface 102d. The electronic form 106a includes a field for entering an Individual ID of an arrestee (e.g. scanned wrist band ID, name and address) and a Individual (current) offense associated with the individual arrestee (e.g. fighting, drinking, throwing objects, verbal threats, disturbing the peace, to name a few). The form fields may be completed through a combination of scanning of arrestee wrist tie, pull-down menus and fill in fields. As mentioned previously, the electronic form 106a may include automated pull downs to facilitate identifying Offense Information for an arrestee.

In accordance with the embodiments, the electronic form 106a is electronically tagged 108 for each arrestee with the mass arrest ID, individual ID, and current offense information for the arrestee (workflow 3). Tagging of each arrestee may include, for example, electronic wrist ties containing a passive RFID tag or other NFC capable device, or optical media such as a bar or QR code, or the like. The electronic wrist tags 108 each contain a unique identifier number which can be communicated via short range link communication to the portable radio 102, for automated entry of the unique arrestee ID number into form 106a. For example, the portable radio may use an RFID reader or other NFC technology, or optical media such as a barcode/QR code reader to obtain and upload the arrestee unique ID number from the wrist tie to the electronic form of the portable radio. The scanned unique identifier number is uploaded as part of the individual ID stored in form 106a as part of arrestee tagged information. The arrestee name and address may be entered by the officer into form 106a as part of the tagged information. For example, a driver's license may be scanned, or other ID entry may be made.

Additional personal attribute information may also be collected by the field officer 110 and stored as part of the electronic form as part of the tagged information. The personal attribute information may include physical attributes and/or cultural attributes. Personal attribute information may include a physical impairment of the arrestee or item associated with a physical impairment of the arrestee; clothing, jewelry, or body markings indicative of a particular culture of an arrestee; clothing, jewelry, or body markings indicative of a particular organization, club, or gang of an arrestee. For example, a cane or dark glasses may be indicative of a vision impaired arrestee; hearing aids or use of sign language may be indicative of hearing impaired arrestee; certain clothing, jewelry, or body markings may be indicative of a particular culture of an arrestee; and other clothing, jewelry, or body markings may be indicative of a particular organization, club, or gang of an arrestee. The personal attribute information may or may not be recognized by the field officer 110 at the incident scene. The completed electronic form 106a including Individual ID (wrist band ID, name, address), Offense Information, and collected Personal Attribute Information associated with each arrestee is stored within the memory 102c of portable radio 102.

In addition to tagging the individual arrestee, the completed electronic form 106a, including the tagged information, is transmitted (workflow 4) from the portable radio 102 back to the server 104 for subsequent server analytics (workflow 5). Upon receipt of completed electronic form 106a containing the tagged information for each arrestee, the server 104 automatically assigns each arrestee to an offense group ID based on current offense type of the arrestee (which was entered under Offense Information).

All arrestees associated with a common offense group may be further refined into sub-groups by the server. The server's processor 104a is further configured to search databases 112, including the one or more public-safety (PS) databases and the one or more open or publicly accessible databases to refine the offense group into sub-groups. In accordance with some embodiments, the server 104 first automatically refines the offense group into sub-groups based on prior arrest records associated with each arrestee via a search of a public safety criminal records database. When prior arrest records are identified, the server 104 may further refine the search to filter criminal record associated with a violent offense and criminal record based on non-violent crime. The processor may be configured to apply weighted scoring, where violent crimes are scored more highly than non-violent crimes. Different fixed weights may be assigned by the server to different levels of violent crime, so that higher scores may generate alerts when exceeding a predetermined threshold for violence.

A server's search resulting in an indication of a violent criminal record of an arrestee (e.g. a conviction for violent felony) may be used as a basis for the server 104 to expand the search to social media. For example, the arrestee may have a social media page indicating membership in certain organizations that are or are associated with hate groups (e.g. anti-LGBTQ hate groups, racial hate groups, cultural hate groups and/or organizations known for violence, destruction of property, and threats).

The personal attribute information of an arrestee may be searched with or without the presence of a criminal record. In some cases, the server search may result in no criminal record, but a search of the collected personal attribute information collected in the electronic form 106a may indicate association of an arrestee with hate groups. Sub-group assignments by the server 104 are directed to separating arrestees with violent criminal records from arrestees with non-violent record, and to further filter out those arrestees without criminal records, but who potentially have, through their personal attribute information, a potential for violent behavior.

The server's search of an arrestee's personal attribute information may also indicate that an arrestee should be assigned to a protected sub-group. For example, an arrestee wearing a particular style of headscarf (search indicates cultural attribute) may need to be in a separate sub-group from arrestees identified with cultural hate groups; a young arrestee may need to be in a separate sub-group from older arrestees (e.g. young arrestee grouped separately from arrestee with record as sex offender).

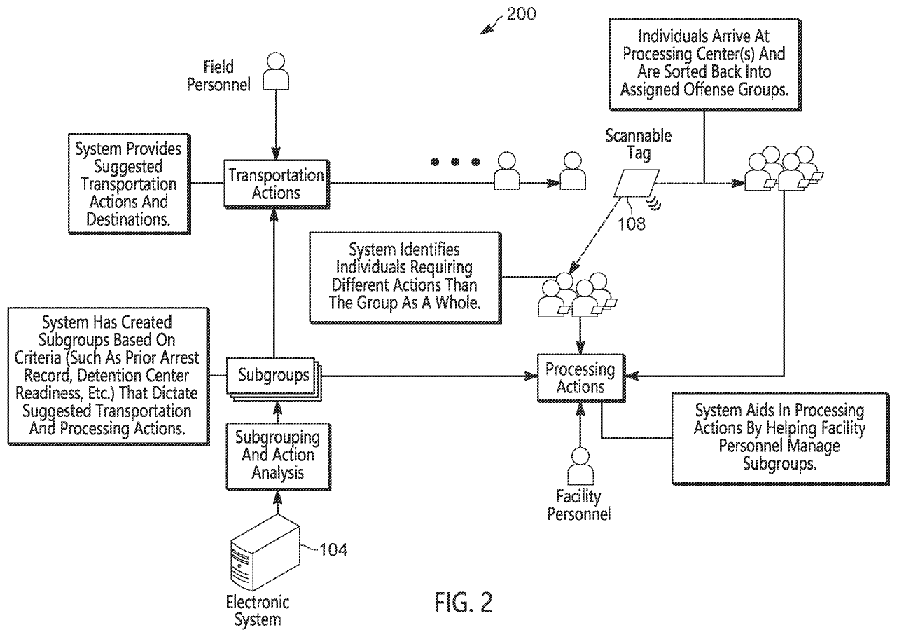

As a result of the server analytics, the server 104 generates automated arrest processing procedure recommendations customized for each sub-group and transmits the sub-group information (identifying individuals in a sub-group) and associated arrest processing procedure recommendations to the PS radio 102 associated with the grouping request. The automated arrest processing procedure recommendations may include transportation processing recommendations and facility processing recommendations (facility processing recommendations described in more detail in conjunction with FIG. 2). The server 104 may also generate alerts along with the processing procedure recommendations when the computed sum associated with an arrestee exceeds a predetermined security risk threshold.

The automated arrest processing procedure recommendations including transportation processing recommendations and facility processing recommendations are transmitted back to portable radio 102 as an updated electronic form 106b (workflow 6). The updated electronic form 106b for each arrestee is received by the portable radio 102 may viewed at the portable radio display. Each updated electronic form 106b may also be uploaded to each electronic tag 108 of each arrestee. For example, the automated arrest processing procedure recommendations are uploaded (as part of the updated electronic form 106b), via short range link from portable radio 102 to an electronic tag 108 of an arrestee. Thus, each arrestee's electronic tag 108 now includes the individual ID, current offense information for the arrestee, personal attribute information (info initially gathered by the radio), and the further mass arrest ID, Offense Group ID, refined sub-group ID, potential alerts, and arrest processing procedure recommendations (including transportation processing recommendations and facility processing recommendations) from the server analytics.

In some embodiments, additional analytics may be requested by field officer 110 via portable radio 102 upon receipt of alerts (workflow 7). For example, a request for additional information pertaining to the alert, or additional updates to personal attribute information being added in response to an alert.

The transportation processing recommendations may include transport safety strategies such as recommendations for bus assignment, bus seating of each arrestee, and bus routing to a public safety detection facility. The bus assignment, bus seating, and bus routing may be optimized for the different identified sub-groups. For example, a processing procedure recommendations may be generated for transporting a sub-group of arrestee(s) wearing identified with cultural attributes may need to be transported separately from sub-groups of arrestee(s) associated with hate group activity towards that identified culture. As another example, a recommendation may be generated for a sub-group of young arrestee to be transported to a juvenile facility, while a recommendation is made for a sub-group of older arrests opposed to be transported to an adult facility.

FIG. 2 illustrates processing actions 200 taking place based on recommendations provided by the communication system of FIG. 1 according to some embodiments. The sub-grouping and action analysis has been completed at 202 and the server 104 sends out sub-group information 206 and processing procedure action recommendations to portable radio 102, in the form of transportation action recommendations 208 and facility processing recommendations. The transportation action recommendations may include transport identification and facility destination, seating, and the like, as previously described, and which may be customized for each sub-group. This sub-group and transport information is stored in portable radio 102 and associated with each unique identifier number of an arrestee's tag. Each respective arrestee tag identifier may be read to bring up the processing procedure recommendations and potential alerts to facilitate safe transport of arrestees.

The field officer 110 may further enter an entry in response to the recommendation, such as recommendation accepted, rejected, or deviated. In accordance with some further embodiments, electronic tags 108 may further be scanned by radios of processing personnel 216 upon arrival at a processing center 212 (jail, juvenile facility, detention center, or the like). The processing actions taken at the processing center 212 may further indicate that arrestees be assigned back to their offense group for facility processing or alternatively that certain arrestees or sub-groups of arrests require different facility processing actions than the offense group as a whole 214. For example, arrestees having violent criminal records can be processed and detained separately from arrestees which non-violent records or no prior records. Arrestees with medical conditions, such as diabetes or epilepsy (physical attributes) prone to seizures, may be assigned to sub-groups designated for arrestees that may require medical attention or medication. Arrestees arriving at a multi-gender facility may be regrouped under their group arrest ID, while remaining in sub-groups pertaining to their gender. Arrestees with physical attributes of transgender or transitioning gender may be processed and detained separately from arrestees of certain hate groups. Hence, even if some or all of the arrestees are being charged with the same main offense, the server generated sub-grouping recommendations and arrest processing procedure recommendations facilitate maintaining safety of arrestees and officers by avoiding further occurrences of potential conflict throughout the arrest process.

The server 104 may further perform post-processing action analysis at 214 to determine which recommendations were accepted, rejected, or deviated from to further adjust and optimize future grouping requests of similar mass incidents.

Accordingly, the communication system 100 provides for processing procedure recommendations generated by the server 104 including transportation processing recommendations and facility processing recommendations. The actions taken by the in-field officer(s) and processing officer(s) may be may be monitored and compared to the recommendation(s) to determine which recommendations were accepted and which were rejected. The arrest processing procedure recommendations can be adjusted for future grouping requests of similar mass incidents based on the accepted recommendations, rejected recommendations and deviated recommendations. The processing procedure recommendations may be periodically scored, for example yearly or monthly, for effectiveness wherein highly scored processing procedure recommendations can be noted when transmitted to the portable radio of an officer dealing with a mass arrest situation. Highly scored processing procedure recommendations associated with certain types of mass arrests can be communicated to other communication systems, such as in other jurisdictions, to help share and build upon proven approaches to mass incident arrests.

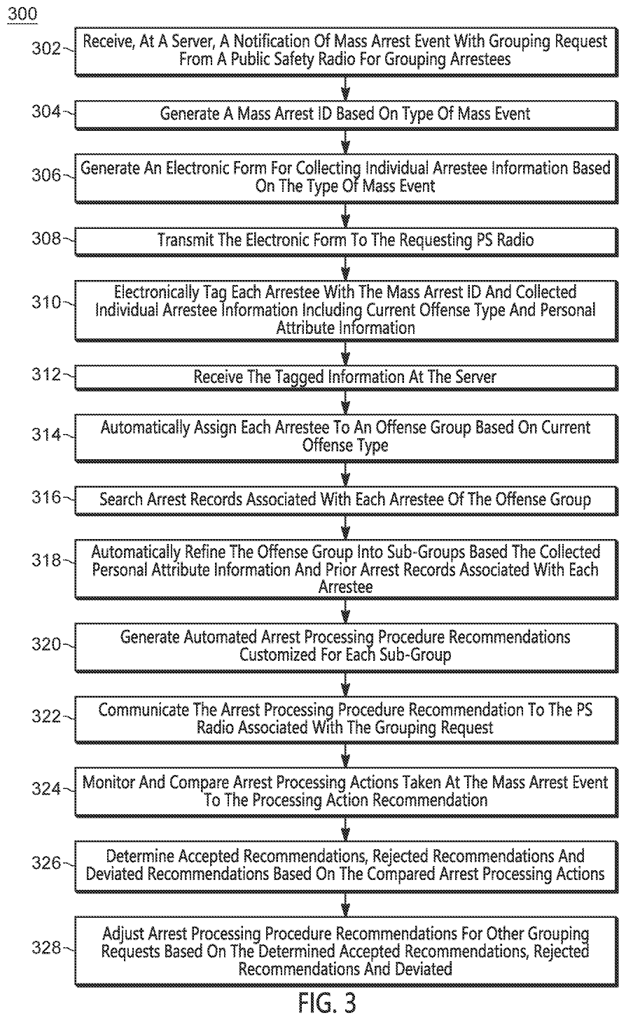

FIG. 3 is a flowchart illustrating a method 300 of managing a mass arrest at an incident scene in accordance with some embodiments. The method begins s at 302 by receiving, at a server, such as server 104 of FIG. 1, an electronic notification from a public safety (PS) radio, such as portable radio 102 of FIG. 1, indicating a mass arrest event with a grouping request for grouping arrestees. In response to the notification, the server generates a mass arrest ID based on type of mass event at 304. The server further generates, at 306, an electronic form for collecting individual arrestee information based on the type of mass event and transmits the electronic form to the requesting PS radio at 308.

The electronic form generated and transmitted by the server at 306, 308 includes the mass arrest ID, and includes fill-in and/or pull-down selection and response menus for collecting individual ID information for each arrestee (e.g. name address) and for collecting offense information associated with each arrestee (e.g. disorderly conduct, assault, battery, to name a few). The form further includes an area to enter personal attribute information associated with an arrestee, physical attributes and/or cultural attributes. For example, a cane or dark glasses indicative of a vision impaired arrestee; hearing aids or use of sign language indicative of hearing impaired arrestee; clothing, jewelry, or body markings indicative of a particular culture of an arrestee.

The method continues at 310 by electronically tagging, by the public safety radio, each arrestee. For example, an individual arrestee may be electronically tagged via electronic wrist ties, each having a unique ID number which is scanned/read and uploaded to the electronic form for each arrestee. The form is then filled out at the portable radio, by the officer, with the collected ID information for each individual arrestee (scanned wrist band ID, name, address) along with current offense type for each individual arrestee and personal attribute information associated with each arrestee. The filled in form for each arrestee is stored within a memory of the portable radio 102 and may be referred to as tagged information associated with each arrestee.

The method continues at 312 with receiving the tagged information at the server, transmitted from the portable radio 102. The method continues at 314 with the server automatically assigning, each arrestee to an offense group based on current offense type associated with each arrestee. The method then continues at 316 with the server searching arrest records associated with each arrestee ID of the offense group. For example, the server may search criminal records to determine whether a member of the offense group has a record of: convicted felon; sex offender; and parole-officer visit to name a few.

In addition to the criminal records being searched based on arrestee ID, the server further conducts searches of publicly available databases based on the collected personal attribute information previously collected for each arrestee by the field officer. Physical attributes (e.g. a particular tattoo, scar symbol, inebriation, body impairment, to name a few) and/or cultural attributes (e.g. particular clothing, head coverings, symbolic jewelry to name a few) may be searched, on open or publicly accessible databases, such as social media portals, local government (e.g., county) records, websites, watch lists and/or registries to name a few. Such searches may indicate membership in certain organizations that are, or are associated, with hate groups (e.g. anti-LGBTQ hate groups, racial hate groups, cultural hate groups and/or organizations known for violence, destruction of property, and threats) or may indicate a need protection from other arrestees.

The method then continues at 318 by automatically refining the offense group into sub-groups based on the collected personal attribute information and the prior arrest records associated with each arrestee. The refining of the offense group into sub-groups, by the server, may further include, for example, computing a sum of fixed weights assigned to different types of criminal records and fixed weights assigned to different types of personal attribute information, as previously described. Fixed weights may be assigned based on criminal record severity, wherein violent crimes are weighted more heavily than non-violent crimes. Different categories of arrestee sub-groups may be formed, such as an arrestee sub-group that needs to be separated based on association with violent behavior, while other arrestee sub-groups may be formed based on a determination of a need for protection, for example based on customs associated with a particular culture.

The method continues at 320 by generating an automated arrest processing procedure recommendations customized for each sub-group. The arrest processing procedure recommendations are stored in, and retrievable from, a memory of the server based on mass incident type, as previously described. For example, the arrest processing procedure recommendations comprise transport safety strategies for transporting arrestees to a public safety detention facility or transporting arrestees to different faculties, and separating some arrestees from others. The transport assignment and separation is directed to maintaining the safety of officers and arrestees. The transport safety strategies may include, for example, recommendations for bus assignment, bus seating of each arrestee, and bus routing to the public safety detection facility. The arrest processing procedure recommendations may also include an alert indicating that a computed sum associated with an arrestee exceeds a predetermined security risk threshold.

The method continues at 322 by transmitting the arrest processing procedure recommendations from the server to the PS radio associated with the grouping request. For example, arrest and transport of a known convicted adult felon would be separated from an underage first time offender. Arrestees who are under the influence of drugs or alcohol would be separated from those not under the influence. The transmission of the arrest processing procedure recommendation may further include sending an alert to the PS radio when the computed sum of fixed weights associated with an arrestee exceeds a predetermined security risk threshold.

The method continues at 324 with monitoring arrest processing actions taken at the mass arrest event and comparing the actions taken (or not taken) to the processing procedure action recommendation at 324 to determine which recommendations were accepted and which were rejected at 326. The method may then continue to 328 by adjusting the arrest processing procedure recommendations for other grouping requests based on the accepted recommendations, rejected recommendations and deviated recommendations. The processing procedure recommendations may be periodically scored, for example yearly or monthly, for effectiveness and highly scored processing procedure recommendations can be noted when transmitted to the portable radio of an officer dealing with a mass arrest situation. Highly scored processing procedure recommendations associated with certain types of mass arrests can be communicated to other communication systems, such as in other jurisdictions, to help share and build upon proven approaches.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The description and drawings merely illustrate the principles of the disclosure. It will thus be appreciated that those of ordinary skill in the art will be able to devise various arrangements that, although not explicitly described or shown herein, embody the principles of the disclosure and are included within its scope. Furthermore, all examples recited herein are principally intended expressly to be only for pedagogical purposes to aid the reader in understanding the principles of the disclosure and the concepts contributed by the inventor(s) to furthering the art and are to be construed as being without limitation to such specifically recited examples and conditions. Moreover, all statements herein reciting principles, aspects, features, examples, and embodiments of the disclosure are intended to encompass various equivalents thereof.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The term “coupled” as used herein is defined as connected, although not necessarily directly and not necessarily mechanically. A device or structure that is “configured” in a certain way is configured in at least that way but may also be configured in ways that are not listed.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (for example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Although the elements in the following method claims are recited in a particular sequence with corresponding labeling, unless the claim recitations otherwise imply a particular sequence for implementing some or all of those elements, those elements are not necessarily intended to be limited to being implemented in that particular sequence.

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method of managing arrests during a mass incident, the method comprising:
receiving, at a server, an electronic notification of mass arrest event with grouping request for grouping arrestees from a public safety (PS) radio (302);
generating a mass arrest ID based on type of mass event (304);
generating an electronic form for collecting individual arrestee information based on the type of mass event (306);
transmitting the electronic form to the requesting PS radio (308);
electronically tagging each arrestee with the mass arrest ID and collected individual arrestee information including current offense type and personal attribute information (310);
receiving the tagged information at the server (312);
automatically assigning, by the server, each arrestee to an offense group based on current offense type (314);
searching arrest records associated with each arrestee of the offense group (316);
automatically refining the offense group into sub-groups based on the personal attribute information and the prior arrest records associated with each arrestee (318);
generating automated arrest processing procedure recommendations customized for each sub-group (320); and
transmitting the arrest processing procedure recommendations from the server to the PS radio associated with the grouping request (322).

2. The method of claim 1, wherein the processing procedure recommendations generated by the server include transportation processing recommendations and facility processing recommendations.

3. The method of claim 1, wherein the personal attribute information comprises at least one of: physical attributes and cultural attributes.

4. The method of claim 1 wherein the arrest processing procedure recommendations comprise transport safety strategies for transporting arrestees to a public safety detention facility.

5. The method of claim 2, wherein the transport safety strategies include recommendations for bus assignment, bus seating of each arrestee, and bus routing to the public safety detection facility.

6. The method of claim 2, wherein automatically refining the offense group into sub-groups further comprises:
computing a sum of fixed weights assigned to different types of criminal records; and
sending an alert to the PS radio along the processing procedure recommendations when the computed sum associated with an arrestee exceeds a predetermined security risk threshold.

7. The method of claim 4, wherein the fixed weights are assigned based on criminal record severity, wherein violent crimes are weighted more heavily than non-violent crimes.

8. The method of claim 1, further comprising:
monitoring and comparing arrest processing actions taken at the mass arrest event to the processing procedure action recommendation (324);
determining accepted recommendations, rejected recommendations and deviated recommendations, based on the compared arrest processing actions (326); and
adjusting the arrest processing procedure recommendations for other grouping requests based on the determined accepted recommendations, rejected recommendations and deviated recommendations (328).

9. The method of claim 1, wherein the arrest processing procedure recommendations are stored in, and retrievable from, a memory of the server based on mass incident type.

10. The method of claim 4, wherein searching the criminal records includes at least one searching criminal records for violent crimes associated with the arrestee.

11. The method of claim 4, wherein the processing procedure recommendations are periodically scored.

12. A communication system, comprising:
a server having a processor configured to:
receive an electronic notification of a mass arrest event with grouping request for grouping arrestees;
generate mass arrest ID based on type of mass event;
generate an electronic form for collecting individual arrestee information based on the type of mass event, the electronic form including fill-in fields for current offense type and personal attribute information for each arrestee;
transmit the electronic form to the requesting PS radio for collection and tagging of current offense type and personal attribute information for each arrestee;
receive tagged information including the current offense type and personal attribute information for each arrestee;
automatically assign each arrestee to an offense group based on current offense type;
search arrest records associated with each arrestee of the offense group;
automatically refine the offense group into sub-groups based on the arrest record and collected personal attribute information associated with each arrestee;
generate automated arrest processing procedure recommendations; and
transmit the arrest processing procedure recommendations from the server to the PS radio associated with the grouping request.

13. The communication system of claim 12, wherein the personal attribute information comprises at least one of: physical attributes and cultural attributes.

14. The communication system of claim 12, wherein the processing procedure recommendations generated by the server include transportation processing recommendations and facility processing recommendations.

15. The communication system of claim 12, wherein the transportation processing recommendations a comprise transport safety strategies for transporting arrestees to a public safety detention facility.

16. The communication system of claim 15, wherein the transport safety strategies include recommendations for bus assignment, bus seating of each arrestee, and bus routing to the public safety detection facility.

17. The communication system of claim 12, wherein the server automatically refines each offense group into sub-groups based on:
a computed sum of fixed weights assigned to different types of criminal records, and the server sends an alert to the PS radio along with the arrest processing procedure recommendations when the computed sum associated with an arrestee exceeds a predetermined security risk threshold.

18. The communication system of claim 17, wherein the fixed weights are assigned based on criminal record severity, wherein violent crimes are weighted more heavily than non-violent crimes.

19. The communication system of claim 12, where the processor of the server is further configured to:
monitor and compare arrest processing actions taken at the mass arrest event to the arrest processing procedure recommendations;
determine accepted recommendations, rejected recommendations and deviated recommendations, based on the compared arrest processing actions; and
adjust the arrest processing procedure recommendations for other grouping requests based on the determined accepted recommendations, rejected recommendations and deviated recommendations.

20. The communication system of claim 12, wherein the arrest processing procedure recommendations are stored in, and retrievable from, a memory of the server based on mass incident type.
